(19) United States
(12) Patent Application Publication
(10) Pub. No.: US 2012/0241649 A1
(43) Pub. Date: Sep. 27, 2012

(54) EXTREME ULTRAVIOLET LIGHT GENERATION APPARATUS AND EXTREME ULTRAVIOLET LIGHT GENERATION METHOD

(75) Inventors: Katsunobu NISHIHARA, Osaka (JP); Atsushi SUNAHARA, Osaka (JP); Osamu WAKABAYASHI, Hiratsuka-shi (JP)

(73) Assignees: OSAKA UNIVERSITY; GIGAPHOTON INC; INSTITUTE FOR LASER TECHNOLOGY

(21) Appl. No.: 13/417,789

(22) Filed: Mar. 12, 2012

(30) Foreign Application Priority Data
Mar. 23, 2011 (JP) 2011-064053

(51) Int. Cl. G21K 5/00

(52) U.S. Cl. 250/504 R

(57) ABSTRACT

An EUV light generation method includes: (1) a step of supplying a target material into a chamber; and (b) a step of generating EUV light from plasma generated by irradiating the target material with a laser beam. The spatial light intensity distribution of the laser beam may be arranged so as to provide a low intensity region with a light intensity lower than a light intensity at a position away from the beam axis by a predetermined distance is present within an area extending for the predetermined distance from the beam axis.

### CROSS-REFERENCE TO RELATED APPLICATION

The present application claims priority from Japanese Patent Application No. 2011-064053 filed Mar. 23, 2011.

### BACKGROUND

1. Technical Field

The present invention relates to an apparatus for generating extreme ultraviolet (EUV) light and a method for generating EUV light.

2. Related Art

In recent years, as semiconductor processes become finer, transfer patterns of photolithography in semiconductor processes have become increasingly finer. In the next generation, microfabrication of 45 nm to 70 nm, and even microfabrication of 32 nm or less will be requested. Accordingly, in response to a request for microfabrication of 32 nm or less, for example, it is expected to develop an exposure apparatus in which an EUV light generation apparatus for generating EUV light at a wavelength of approximately 13 nm and a reduced projection reflective optical system are combined.

Three types of EUV light generation apparatuses have been proposed: a laser produced plasma (LPP) type apparatus, which uses plasma generated by irradiation of a target material with a laser beam, a discharge produced plasma (DPP) type apparatus, which uses plasma generated by discharge, and a synchrotron radiation (SR) type apparatus, which uses orbital radiation light.

U.S. Pat. No. 6,973,164 discloses a related art of an EUV radiation source that uses a low-energy laser prepulse immediately before a high-energy laser main pulses. In U.S. Pat. No. 6,973,164, however, it is difficult to obtain a sufficient conversion efficiency (CE) from the energy of a laser pulse to the energy of EUV light.

### SUMMARY OF THE INVENTION

An object of an aspect of the present invention addresses the above problem with the object of improving the conversion efficiency in the generation of EUV light.

An extreme ultraviolet light generation method according to an aspect of the present invention includes: (a) a step of supplying a target material into a chamber; and (b) a step of generating extreme ultraviolet light from plasma generated by irradiating the target material with a laser beam, the laser beam having a spatial light intensity distribution in which a low intensity region with a light intensity lower than a light intensity at a position away from a beam axis by a predetermined distance is present within an area extending for the predetermined distance from the beam axis at an irradiation position of the target material.

An extreme ultraviolet light generation apparatus according to another aspect of the present invention includes: a chamber, a target supplier that supplies a target material into the chamber, at least one optical element that introduces a laser beam for irradiating the target material to generate plasma into the chamber, and a light intensity distribution adjusting optical system that adjusts a spatial light intensity distribution of the laser beam at an irradiation position of the target material such that a low intensity region with a light intensity lower than a light intensity at a position away from a beam axis by a predetermined distance is present within an area extending for the predetermined distance from the center of the beam axis.

According to the above aspects of the invention, at an irradiation position of the target material, the target material is irradiated with a laser beam with a spatial light intensity distribution in which a low intensity region with a light intensity lower than that at a position away from a beam axis by a predetermined distance is present within an area extending for the predetermined distance from the center of the beam axis. With this, the conversion efficiency in generating EUV light can be improved.

### BRIEF DESCRIPTION OF THE DRAWINGS

FIG. 1 shows a general structure of an example of an LPP type EUV light generation apparatus according to an aspect of this disclosure.

FIG. 2A shows a light intensity distribution of a laser beam, and simulation results of a ratio of absorption in a target material and an EUV conversion efficiency in a comparative example.

FIG. 2B shows a first example of the light intensity distribution of a laser beam, and simulation results of the ratio of absorption in the target material and the EUV conversion efficiency in this disclosure.

FIG. 2C shows a second example of the light intensity distribution of a laser beam, and simulation results of the ratio of absorption in the target material and the EUV conversion efficiency in this disclosure.

FIG. 2D shows a third example of the light intensity distribution of a laser beam, and simulation results of the ratio of absorption in the target material and the EUV conversion efficiency in this disclosure.

FIG. 2E shows a fourth example of the light intensity distribution of a laser beam, and simulation results of the ratio of absorption in the target material and the EUV conversion efficiency in this disclosure.

FIG. 2F shows a fifth example of the light intensity distribution of a laser beam, and simulation results of the ratio of absorption in the target material and the EUV conversion efficiency in this disclosure.

FIG. 3A shows the simulation results of an electron density distribution and an electron temperature distribution near an irradiation surface of the target material when the target material is irradiated with a laser beam with the light intensity distribution shown in FIG. 2E.

FIG. 3B shows the light intensity distribution in FIG. 2E that is enlarged according to the display dimension in FIG. 3A.

FIG. 4 is a diagram showing a first embodiment of a light intensity distribution adjusting optical system.

FIG. 5 is a diagram showing a second embodiment of the light intensity distribution adjusting optical system.

FIG. 6 is a diagram showing a third embodiment of the light intensity distribution adjusting optical system.

FIG. 7 is a diagram showing a fourth embodiment of the light intensity distribution adjusting optical system.

FIG. 8A is a diagram showing a fifth embodiment of the light intensity distribution adjusting optical system.

FIG. 8B shows a surface on which a diffraction grating is formed.

FIG. 8C is an enlarged view showing a section of the diffraction grating.

FIG. 9A is a diagram showing a sixth embodiment of the light intensity distribution adjusting optical system.

FIG. 9B shows a surface on which a diffraction grating is formed.

FIG. 9C is an enlarged view showing a section of the diffraction grating.

FIG. 10 is a diagram showing a seventh embodiment of the light intensity distribution adjusting optical system.

FIG. 11A is a diagram showing an eighth embodiment of the light intensity distribution adjusting optical system.

FIG. 11B shows an example of a light intensity distribution formed by the light intensity distribution adjusting optical system shown in FIG. 11A, viewed in the direction of irradiation with the laser beam.

FIG. 11C shows a light intensity distribution along the X-axis in FIG. 11B.

FIG. 12 is a diagram showing a target supplier in a ninth embodiment.

### DESCRIPTION OF PREFERRED EMBODIMENTS

### Table of Contents

### 1. Overview

### 2. Description of Terms

### 3. General Description of EUV Light Generation Apparatus

### 3.1 Structure

### 3.2 Operation

### 4. Examples of Beam Intensity Distributions

### 5. Embodiments of Beam Intensity Distribution Adjusting Optical System

5.1 System for Generating Annular Beam and Focusing with Focusing Optical System
5.1.1 Generating Annular Beam with Axicon Lens
5.1.2 Generating Annular Beam with Axicon Mirror
5.2 Method of Forming Focus with Focusing Optical System by Bending Beam Axisymmetrically
5.2.1 Forming Annular Distribution with Axicon Lens and Focusing Optical System
5.2.2 Forming Core and Hollow Distribution with Axicon Lens and Focusing Optical System
5.2.3 Forming Annular Distribution with Concentric Diffraction Grating and Focusing Optical System
5.2.4 Forming Core and Hollow Distribution with Concentric Diffraction Grating and Focusing Optical System

### 5.2.5 Integration of Concentric Diffraction Grating and Focusing Optical System

5.3 Forming Desired Beam intensity Distribution Using Diffraction Optical Element and Focusing Optical System

### 6. Embodiment of Target Supplier

Embodiments of this disclosure will be described in details with reference to the drawings. The embodiments described below only indicate examples of this disclosure and do not limit the scope of this disclosure. Further, configurations and operations described in each embodiment are not all essential in implementing this disclosure. It should be noted that like elements are referenced by like reference symbols and duplicate descriptions thereof will be omitted.

### 1. Overview

In each embodiment of this disclosure, optimization of the light intensity distribution of a laser beam that irradiates the target material in the chamber is made to improve the conversion efficiency (CE).

### 2. Description of Terms

Terms used in this application will be described. The “chamber” separates a space where EUV light is generated, from the air. The “target supplier” is a device for supplying a target material, such as tin, used to generate EUV light into the chamber. The “laser beam” excites a target material into plasma. The “EUV collector mirror” collects EUV light emitted from plasma and outputs the EUV light outside the chamber.

### 3. General Description of EUV Light Generation Apparatus

### 3.1 Structure

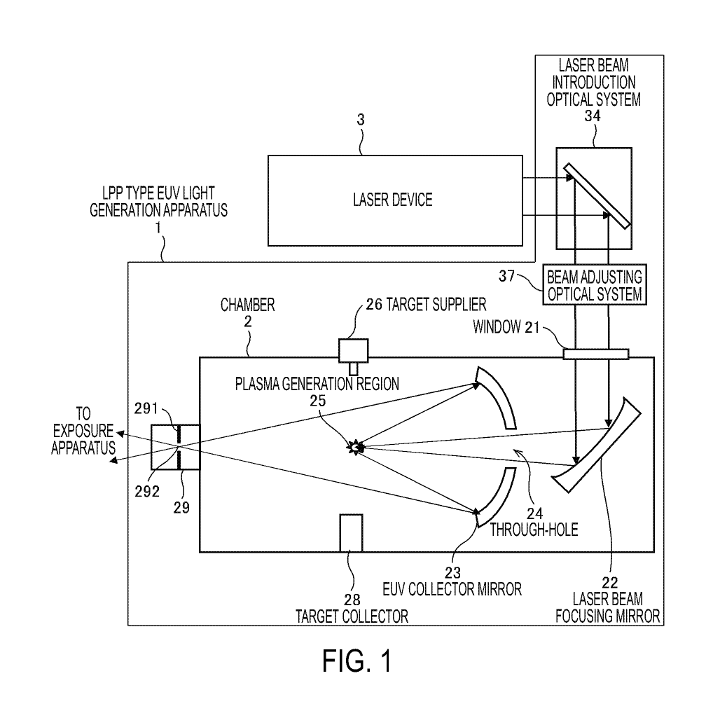

FIG. 1 shows a general structure of an example of an LPP type EUV light generation apparatus according to an aspect of this disclosure. The LPP type EUV light generation apparatus 1 can be used together with at least one laser device 3 (a system including the LPP type EUV light generation apparatus 1 and the laser device 3 is referred to below as an EUV light generating system). The LPP type EUV light generation apparatus 1 can include a chamber 2, as illustrated in FIG. 1 and described in details below. The chamber 2 is preferably kept in a vacuum. Alternatively, the chamber 2 may contain a gas with high EUV light transmittance. The LPP type EUV light generation apparatus 1 can further include a target supplier 26. The target supplier 26 may be mounted on, for example, a wall of the chamber 2. The target supplier 26 can supply tin, terbium, gadolinium, lithium, xenon, or a combination of two or more of them into the chamber 2. However, materials of the target are not limited to them.

At least one window 21 through which a laser beam generated by the laser device 3 passes may be disposed in the chamber 2. For example, an EUV collector mirror 23 with a spheroidal reflective surface may be placed in the chamber 2. The spheroidal mirror has a first focal point and a second focal point. A multi-layer reflective film including alternately laminated molybdenum and silicon layers may be formed on a surface of the EUV collector mirror 23. It is preferable that the EUV collector mirror 23 be arranged so that, for example, the first focal point is placed at or near a plasma generation position (plasma generation region 25) and the second focal point is placed at a desired focusing position (intermediate focus (IF) 292) defined according to the specification of an exposure apparatus. A through-hole 24 may be disposed at the center of the EUV collector mirror 23. A laser beam generated by the laser device 3 can pass through the through-hole 24.

In addition, the LPP type EUV light generation apparatus 1 can include a communication tube 29 that communicates the inside of the chamber 2 with the inside of the exposure apparatus. The communication tube 29 can include a wall 291 in which an aperture is formed, and the wall 291 can be arranged so that the aperture is placed at the second focal point of the EUV collector mirror 23. In addition, the LPP type EUV light generation apparatus 1 can include a laser beam introduction optical system 34, a laser beam focusing mirror 22, a target collector 28, etc.

A beam adjusting optical system 37 is placed in the beam path of a laser beam generated by the laser device 3. The beam adjusting optical system 37 and the laser beam focusing mirror 22 are included in the light intensity distribution adjusting optical system. The beam adjusting optical system 37 is an optical element that adjusts the laser beam so that the shape of a light intensity distribution along a section orthogonal to the beam axis becomes ring-shaped, refracts or reflects the laser beam at a certain angle axisymmetrically with respect to the beam axis, or gives the laser beam a phase difference of a predetermined pattern. The laser beam emitted from the beam adjusting optical system 37 is focused by the focusing optical system such as the laser beam focusing mirror 22 and strikes the target material. Accordingly, the spatial light intensity distribution of the laser beam at the irradiation position of the target material becomes a spatial light intensity distribution in which a low intensity region with a light intensity lower than that at a position away from a beam axis by a predetermined distance is present within an area extending for the predetermined distance from the center of the beam axis. The beam adjusting optical system 37 may be placed in a beam path in the laser device 3.

### 3.2 Operation

The laser beam emitted from the laser device 3 may enter the chamber 2 after passing through the window 21 via the laser beam introduction optical system 34. The laser beam may travel along at least one laser beam path into the chamber 2, may be reflected by the laser beam focusing mirror 22, and then may be focused on and strike the target material.

The target supplier 26 may output the target material toward the plasma generation region 25 inside the chamber 2. The target material is irradiated with the laser beam. The target material irradiated with the laser beam is turned into plasma and EUV light is generated from the plasma. The EUV light is reflected by the EUV collector mirror 23. The reflected EUV light is focused at the intermediate focus 292 and then output to the exposure apparatus.

### 4. Examples of Beam Intensity Distributions

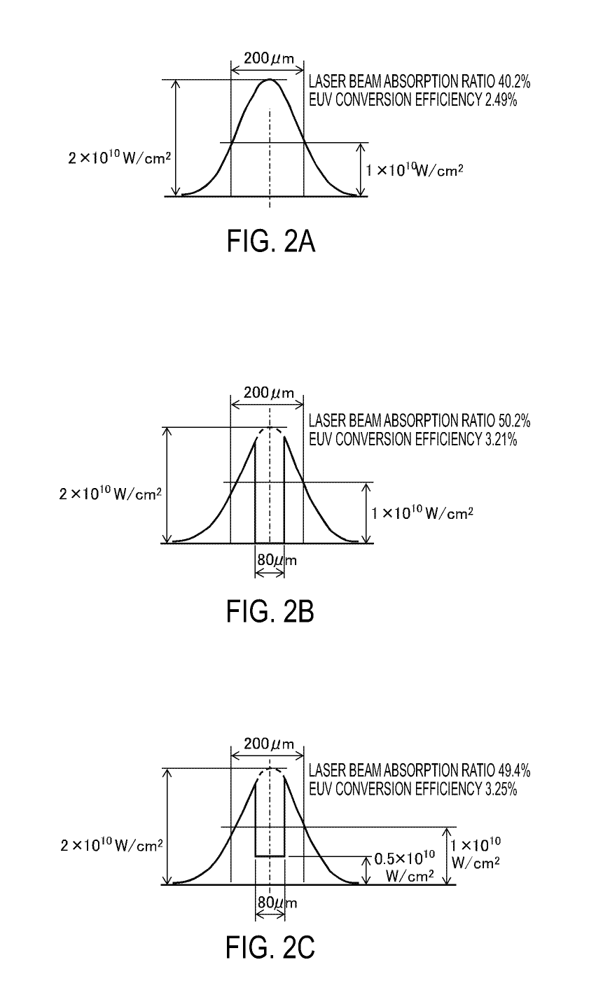

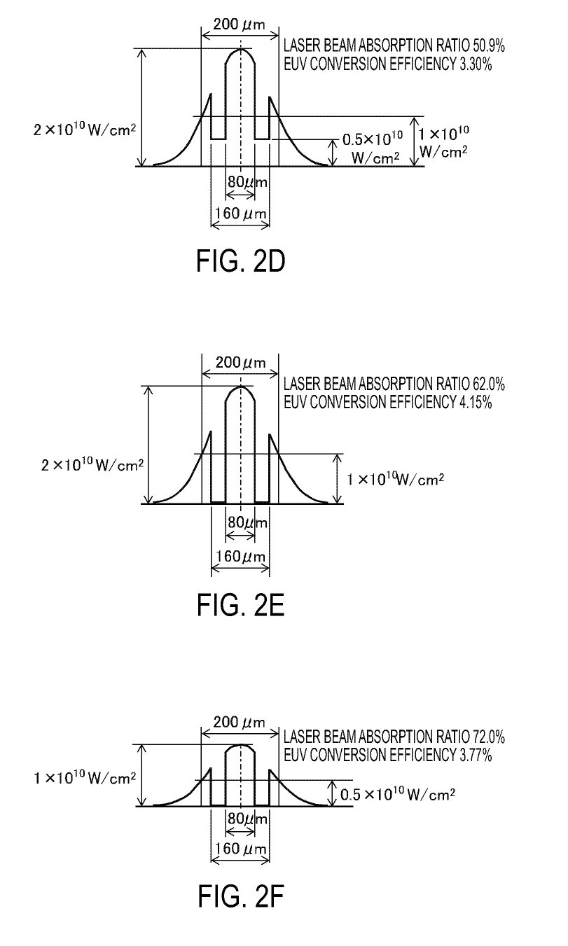

FIG. 2A shows a light intensity distribution at a position where the target material is irradiated with a laser beam, and simulation results of the ratio of absorption in the target material and the EUV conversion efficiency in a comparative example. For simplicity of description, hereinafter, a light intensity distribution in a section orthogonal to the beam axis is merely referred to as a light intensity distribution, not only in the present embodiment. FIG. 2A shows a case where the light intensity distribution of a laser beam is a Gaussian distribution, as a comparative example. The diameter of this laser beam is 200 μm (full width at half maximum) and the peak intensity is 2×10¹⁰ W/cm². This simulation assumes that this laser beam orthogonally enters a flat surface of metal tin. As a result of the simulation, the ratio of absorption of the laser beam in the target material is 40.2% and the EUV conversion efficiency is 2.49% in the comparative example.

FIG. 2B shows a first example of a light intensity distribution at a position where the target material is irradiated with the laser beam, and simulation results of the ratio of absorption in the target material and the EUV conversion efficiency in this disclosure. In the first example, the light intensity distribution of the laser beam is such that the light intensity, of the Gaussian distribution having the same beam diameter and peak intensity as in the comparative example, is assumed to be 0 in an area where the distance from the center is 0 μm to 40 μm. This simulation assumes that the laser beam orthogonally enters a flat surface of metal tin. As a result of the simulation, the ratio of the absorption in the target material in the first example is increased to 50.2% and the EUV conversion efficiency is increased to 3.21%, as compared with the comparative example.

FIG. 2C shows a second example of a light intensity distribution at a position where the target material is irradiated with the laser beam, and simulation results of the ratio of absorption in the target material and the EUV conversion efficiency in this disclosure. In the second example, the light intensity distribution of the laser beam is such that the light intensity, of the Gaussian distribution having the same beam diameter and peak intensity as in the comparative example, is assumed to be a quarter of the peak intensity in an area where the distance from the center is 0 μm to 40 μm. This simulation assumes that the laser beam orthogonally enters a flat surface of metal tin. As a result of the simulation, the ratio of the absorption in the target material in the second example is increased to 49.4% and the EUV conversion efficiency is increased to 3.25%, as compared with the comparative example.

FIG. 2D shows a third example of a light intensity distribution at a position where the target material is irradiated with the laser beam, and simulation results of the ratio of absorption in the target material and the EUV conversion efficiency in this disclosure. In the third example, the light intensity distribution of the laser beam is such that the light intensity, of the Gaussian distribution having the same beam diameter and peak intensity as in the comparative example, is assumed to be a quarter of the peak intensity in an area where the distance from the center is 40 μm to 80 μm. This simulation assumes that the laser beam orthogonally enters a flat surface of metal tin. As a result of the simulation, the ratio of the absorption in the target material in the third example is increased to 50.9% and the EUV conversion efficiency is increased to 3.30%, as compared with the comparative example.

FIG. 2E shows a fourth example of a light intensity distribution at a position where the target material is irradiated with the laser beam, and simulation results of the ratio of absorption in the target material and the EUV conversion efficiency in this disclosure. In the fourth example, the light intensity distribution of the laser beam is such that the light intensity, of the Gaussian distribution having the same beam diameter and peak intensity as in the comparative example, is assumed to be 0 in an area where the distance from the center is 40 μm to 80 μm. This simulation assumes that the laser beam orthogonally enters a flat surface of metal tin. As a result of the simulation, the ratio of the absorption in the target material in the fourth example is increased to 62.0% and the EUV conversion efficiency is increased to 4.15%, as compared with the comparative example.

FIG. 2F shows a fifth example of a light intensity distribution at a position where the target material is irradiated with the laser beam, and simulation results of the ratio of absorption in the target material and the EUV conversion efficiency in this disclosure. The light intensity distribution of a laser beam in the fifth example is arranged so that the laser beam has a light intensity half of the light intensity of the laser beam in the fourth example. This simulation assumes that the laser beam orthogonally enters a flat surface of metal tin. As a result of the simulation, the ratio of the absorption in the target material in the fifth example is increased to 72.0% and the EUV conversion efficiency is increased to 3.77%, as compared with the comparative example.

It can be seen from the results of the above simulation that, in the spatial light intensity distribution of the laser beam, a low intensity region with a light intensity lower than that in the vicinity (first high intensity region) of ends of the full width at half maximum of the light intensity is preferably present within the full width at half maximum. For example, an annular light intensity distribution as shown in FIGS. 2B and 2C or a core and hollow light intensity distribution, which has a second high intensity region with a high light intensity in the center near the beam axis as shown in FIGS. 2D, 2E, and 2F, are preferable. A sharp rise in light intensity is preferably present between the first high intensity region and the low intensity region located inside the first high intensity region and having a lower light intensity and between the low intensity region with a low light intensity and the second high intensity region located inside the low intensity region and having a higher intensity.

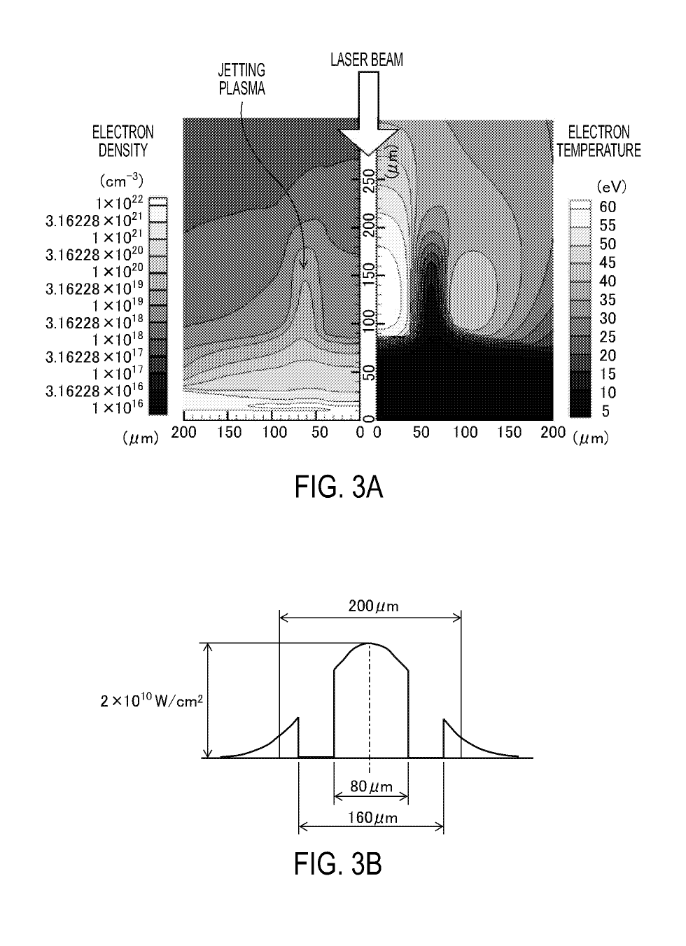

FIG. 3A shows the simulation results of an electron density distribution and an electron temperature distribution near an irradiation surface of the target material when the target material is irradiated with a laser beam having the light intensity distribution shown in FIG. 2E. FIG. 3B shows the light intensity distribution in FIG. 2E that is enlarged according to the display dimension in FIG. 3A. When the target material is irradiated with a laser beam, the target material is excited and turned into plasma. Plasma expands from the irradiation surface of the target material. This plasma includes electrons and ions.

It is found from the simulation results that, while the electron temperature becomes very high at a portion of a laser beam with a high light intensity, the electron density thereof does not become very high. It is also found from the simulation results that, in the space (low intensity region with a low light intensity) between beam paths in a portion with a high light intensity of a laser beam, the electron density becomes very high, but the electron temperature does not become very high.

A laser beam with the light intensity distribution shown in FIG. 2E has a core and hollow light intensity distribution including the first high intensity region and the second high intensity region. Accordingly, it is speculated that the plasma is confined within a cylindrical portion (with a low light intensity) between beam paths in these high-light-intensity regions to increase the density thereof. The high density plasma in the cylindrical portion (with a low light intensity) jets out in a direction opposite to the travel direction of the laser beam. In the second high intensity region with a high light intensity, plasma with a higher temperature generates and is going to expand. However, it is speculated that, since the second high intensity region is surrounded by the cylindrical portion (with a low light intensity) containing the high density plasma, a plasma flow from the second high intensity region to the outside is suppressed. That is, it is thought that the plasma blown out from the target material by irradiation with the laser beam is jetted at a portion with a low light intensity of a laser beam to prevent the plasma generated in a portion with a high light intensity from diffusing in a direction along the surface of the target. It is speculated that the plasma generated at the high-light-intensity portion diffuses in a direction opposite to the travel direction of the laser beam to expand a region having a density appropriate for absorption of a laser beam. As a result, it is thought that the plasma generated in the portion with a high light intensity absorbs the laser beam efficiently and is heated to a high temperature to improve the conversion efficiently. It is speculated that one reason for the improvement of the conversion efficiency in the examples shown in FIGS. 2B to 2F is that the plasma is efficiently heated as described above.

### 5. Embodiments of Beam Intensity Distribution Adjusting Optical System

Next, embodiments related to a light intensity distribution adjusting optical system will be described. As examples of the light intensity distribution adjusting optical system, a system that generates an annular beam and focus the annular beam with a focusing optical system, a system that bends a beam axisymmetrically and forms a focus with a focusing optical system, and a system that forms a desired light intensity distribution with a diffraction optical element will be described below.

5.1 System Generating Annular Beam and Focusing with Focusing Optical System
5.1.1 Generating Annular Beam with Axicon Lens

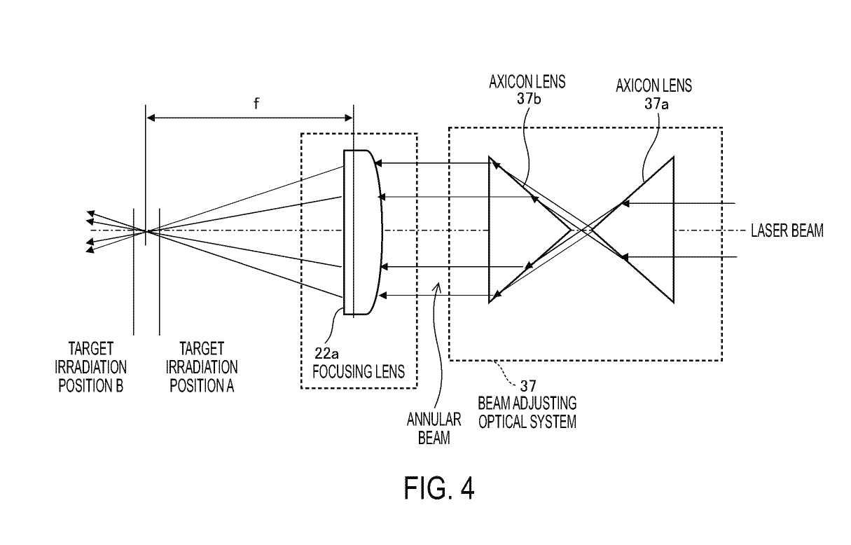

FIG. 4 is a diagram showing a first embodiment of the light intensity distribution adjusting optical system. The light intensity distribution adjusting optical system according to the first embodiment includes two axicon lenses 37a and 37b as the beam adjusting optical system 37.

The axicon lenses 37a and 37b are conical lens. The axicon lenses 37a and 37b are spaced apart so that their vertices face each other. The axicon lenses 37a and 37b are arranged so that their rotational symmetry axes are substantially aligned with the optical axis of the laser beam. When a laser beam is incident on the bottom of the axicon lens 37a, an annular beam is output from the bottom of the other axicon lens 37b.

The annular beam is focused by the focusing lens 22a and a focus is formed at a point away from the principal surface of the focusing lens 22a by a focal distance f. The light intensity distribution at this focus is a Gaussian distribution that has a high light intensity at the center and a low light intensity at the periphery. However, the light intensity distribution in position A or position B, which is to the front or rear of the focus, respectively, is an annular distribution having a low intensity at the center, which is similar to the distributions shown in FIGS. 2B and 2C. Accordingly, irradiation with the laser beam in position A or position B can improve the conversion efficiency.

The focusing optical system for focusing an annular beam is not limited to the focusing lens 22a and may be a focusing mirror.

5.1.2 Generating Annular Beam with Axicon Mirror

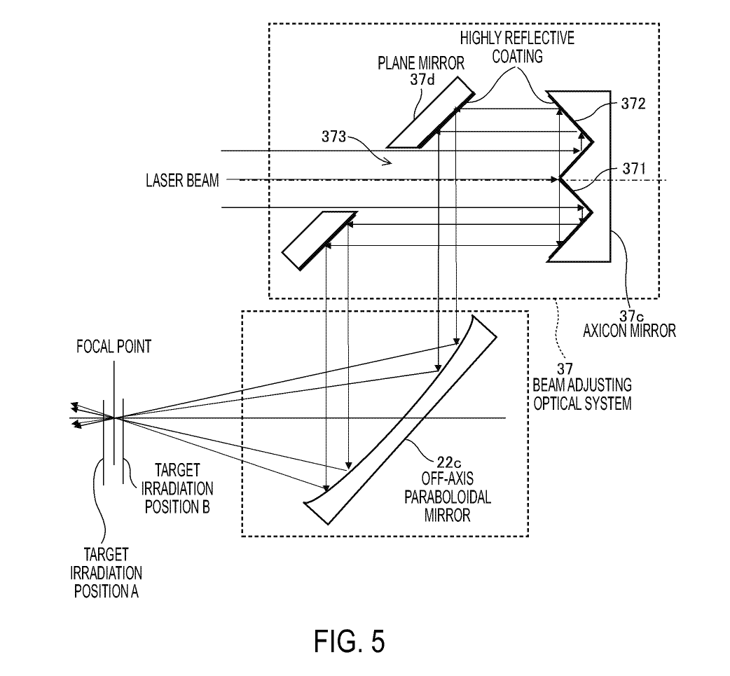

FIG. 5 is a diagram showing a second embodiment of the light intensity distribution adjusting optical system. The light intensity distribution adjusting optical system according to the second embodiment includes an axicon mirror 37c and a plane mirror 37d as the beam adjusting optical system 37.

The axicon mirror 37c is a W-axicon mirror in which a first reflective surface 371 having a conical side face and a second reflective surface 372 shaped in a side face of a circular truncated cone arranged outside the first reflective surface are combined. The slant angle with respect to the rotational symmetry axis of the first reflective surface 371 and the slant angle with respect to the rotational symmetry axis of the second reflective surface 372 are, for example, both 45 degrees. Alternatively, the slant angles may be defined so that the sum of the slant angle with respect to the rotational symmetry axis of the first reflective surface 371 and the slant angle with respect to the rotational symmetry axis of the second reflective surface 372 becomes 90 degrees. The axicon mirror 37c is arranged so that the rotational symmetry axis thereof is substantially aligned with the optical axis of the laser beam. The first reflective surface 371 and the second reflective surface 372 are coated with a highly reflective film corresponding to the wavelength of the laser beam.

The plane mirror 37d has a through-hole 373 at its center and is arranged so that the rotational symmetry axis of the axicon mirror 37c passes through the through-hole 373. The reflective surface of the plane mirror 37d faces the reflective surface of the axicon mirror 37c and is arranged at a slant angle with respect to the rotational symmetry axis of the axicon mirror 37c. The reflective surface of the plane mirror 37d is coated with a highly reflective film corresponding to the wavelength of the laser beam.

The laser beam passing through the through-hole 373 from the rear of the plane mirror 37d is reflected by the first reflective surface 371 of the axicon mirror 37c outwardly, reflected again by the second reflective surface 372 to form an annular beam, and the annular beam is output from the axicon mirror 37c. The annular beam output from the axicon mirror 37c is reflected by the reflective surface on the front side of the plane mirror 37d toward an off-axis paraboloidal mirror 22c.

The off-axis paraboloidal mirror 22c is shaped in a paraboloid and focuses incident parallel beams at a predetermined focal point. The annular beam reflected by the plane mirror 37d is focused by the off-axis paraboloidal mirror 22c at the focal point of the off-axis paraboloidal mirror 22c. The light intensity distribution at this focal point is, for example, a Gaussian distribution. However, the light intensity distribution at a position A or position B, which is to the front or rear of the focal point, respectively, is an annular distribution having a low intensity region at the center. Accordingly, irradiation with a laser beam at the position A or position B can improve the conversion efficiency.

Since the light intensity distribution adjusting optical system includes reflective optical elements in the second embodiment, a mechanism for cooling the optical elements can be provided to suppress overheating in the optical elements. Accordingly, even if a high power laser beam enters the light intensity distribution adjusting optical system, deformation of the optical elements due to thermal expansion and the distortion of the wavefront are suppressed. The focusing optical system for focusing an annular beam is not limited to the off-axis paraboloidal mirror 22c but another focusing mirror or a focusing lens may be used. A mirror having a through-hole is not limited to the plane mirror 37d but a curved mirror such as an off-axis paraboloidal mirror may be used.

5.2 Method of Forming Focus with Focusing Optical System by Bending Beam Axisymmetrically
5.2.1 Forming Annular Distribution with Axicon Lens and Focusing Optical System

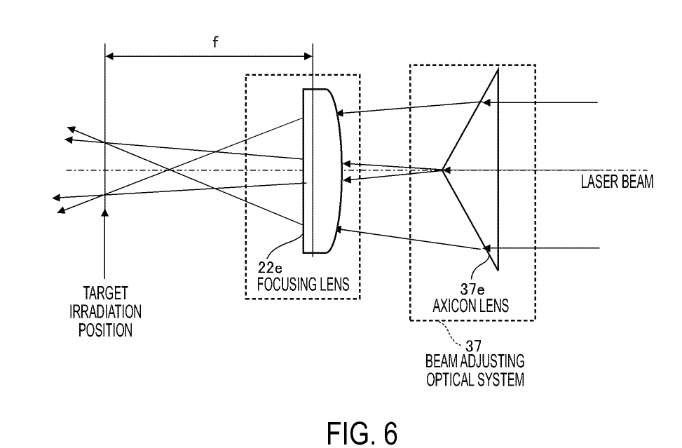

FIG. 6 is a diagram showing a third embodiment of the light intensity distribution adjusting optical system. The light intensity distribution adjusting optical system according to the third embodiment includes an axicon lens 37e as the beam adjusting optical system 37 and a focusing lens 22e as the focusing optical system.

The axicon lens 37e is a conical lens. The axicon lens 37e is arranged so that the rotational symmetry axis thereof is substantially aligned with the optical axis of the laser beam. The laser beam incident on the axicon lens 37e is refracted axisymmetrically with respect to the rotational symmetry axis of the axicon lens 37e at a certain angle regardless of the distance from the rotational symmetry axis, and exits the axicon lens 37e.

The beam that exited the axicon lens 37e is focused by the focusing lens 22e at a position away from the principal surface of the focusing lens 22e by the focal distance f. The light intensity distribution at this focusing position is an annular distribution with a low intensity region at the center. Accordingly, irradiation of the target material with the laser beam at this focusing position can improve the conversion efficiency.

The focusing optical system is not limited to the focusing lens 22e but may be a focusing mirror. An axicon convex lens is used as the axicon lens 37e in this example, but an axicon concave lens may also be used. Alternatively, an axicon mirror may be used instead of an axicon lens.

Since an annular beam can be focused at the focal point of the focusing lens 22e according to the third embodiment, the target material can be irradiated with an annular-shaped laser beam with a sharp rise in light intensity.

5.2.2 Forming Core and Hollow Distribution with Axicon Lens and Focusing Optical System

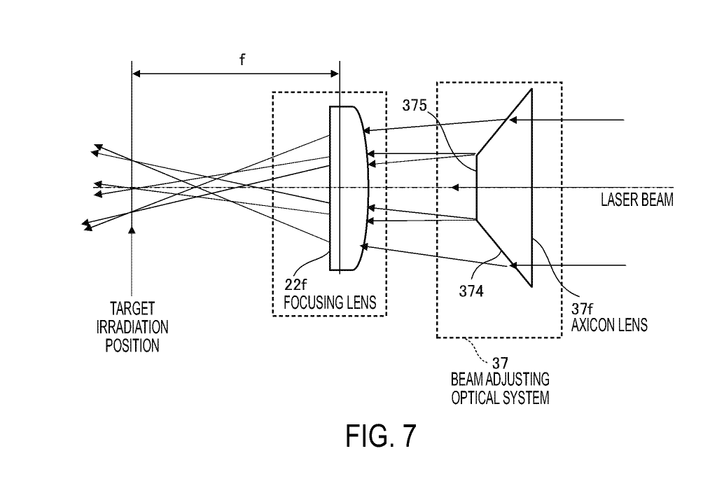

FIG. 7 is a diagram showing a fourth embodiment of the light intensity distribution adjusting optical system. The light intensity distribution adjusting optical system according to the fourth embodiment includes an axicon lens 37f as the beam adjusting optical system 37 and a focusing lens 22f as the focusing optical system.

The axicon lens 37f is a truncated-cone-shaped lens. The axicon lens 37f is arranged so that the rotational symmetry axis thereof is substantially aligned with the optical axis of the laser beam. The laser beam passing through a slanted side 374 of the axicon lens 37f is refracted axisymmetrically with respect to the rotational symmetry axis of the axicon lens 37f at a certain angle regardless of the distance from the rotational symmetry axis, and exits the axicon lens 37f. The laser beam passing through a plane part 375 at the center of the axicon lens 37f exits the axicon lens 37f without its travel direction being changed.

The beam that exited the axicon lens 37f is focused by the focusing lens 22f at a position away from the principal surface of the focusing lens 22f by the focal distance f. The laser beam that passed through the plane part 375 at the center of the axicon lens 37f is focused in the vicinity of the optical axis and the laser beam that passed through the slanted side 374 of the axicon lens 37f is focused annularly at a position outside the optical axis. Accordingly, the light intensity distribution at the focusing position is a core and hollow distribution having the first high intensity region, the low intensity region located inside the first high intensity region, and the second high intensity region located inside the low intensity region. Irradiation of the target material with the laser beam at this focusing position can improve the conversion efficiency.

The focusing optical system is not limited to the focusing lens 22f but may be a collector mirror. The axicon lens 37f in this description is a truncated-cone-shaped axicon lens having the plane part 375 in the center and the slanted side 374 as its external surface, but another type of axicon lens may be used. For example, an axicon lens having a slanted part with a conical side at the center and a plane part at an outside thereof may also be used. An axicon convex lens is used as the axicon lens 37f in this example, but an axicon concave lens may also be used. Alternatively, an axicon mirror may be used instead of an axicon lens.

Since a core and hollow beam can be focused at the focal point of the focusing lens 22f according to the fourth embodiment, the target material can be irradiated with a core and hollow laser beam with a sharp rise in light intensity.

5.2.3 Forming Annular Distribution with Concentric Diffraction Grating and Focusing Optical System

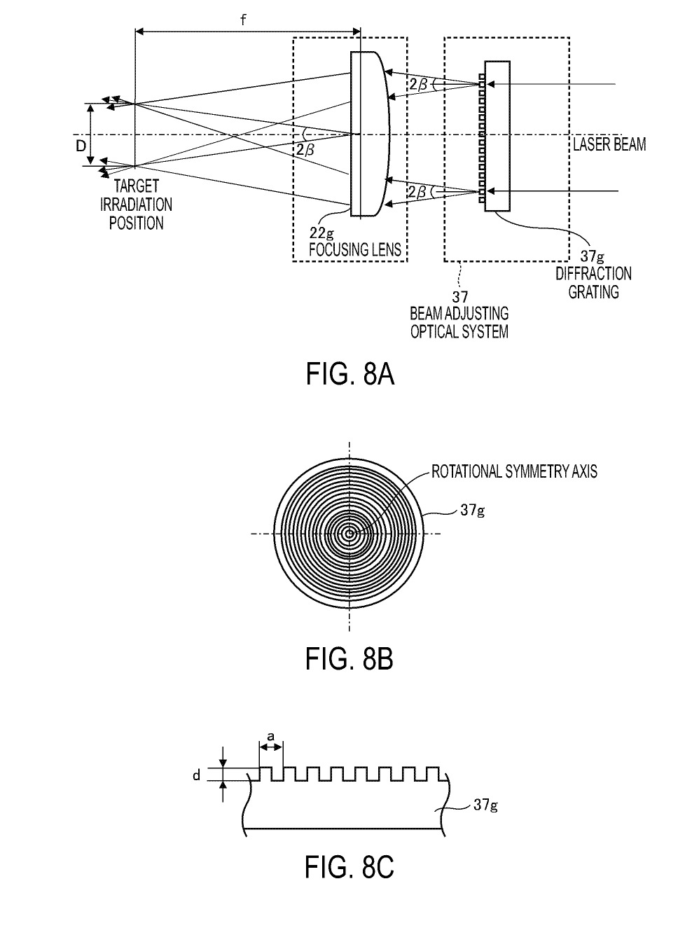

FIG. 8A is a diagram showing a fifth embodiment of the light intensity distribution adjusting optical system. The light intensity distribution adjusting optical system according to the fifth embodiment includes a diffraction grating 37g as the beam adjusting optical system 37 and a focusing lens 22g as the focusing optical system. FIG. 8B shows a surface on which a diffraction grating is formed; and FIG. 8C shows an enlarged view of a section of the diffraction grating.

As shown in FIGS. 8A and 8B, the diffraction grating 37g is a transmissive diffraction grating having concentric grooves formed thereon. The diffraction grating 37g is arranged so that the rotational symmetry axis thereof is substantially aligned with the optical axis of the laser beam. As shown in FIG. 8C, the section of grooves of the diffraction grating 37g is rectangular. The grooves are machined so as to have a depth d represented by the following expression.

d=λ/{2(n−1)} (1)

Here, λ is the wavelength of the laser beam; and n is the refractive index of the diffraction grating 37g.

When a beam is orthogonally incident on the diffraction grating 37g (i.e., when the incident angle is 0 degree) as shown in FIG. 8A, the phases of the beam refracted by a plurality of grooves match to increase the amplitude on the conditions indicated by the following expression.

mλ=a·sinβ (2)

Here, m is the order of diffraction; λ is the wavelength of the beam; a is the groove pitch; and β is the exit angle. Accordingly, the exit angle β is indicated by the following expression.

β=sin⁻¹ (mλ/a) (3)

If the depth of the grooves is set as indicated by expression (1) above, since a phase difference π is caused between a beam passing through the grooves and a beam passing through the crests (i.e., the parts other than the grooves), the zeroth-order diffracted light is weakened. Accordingly, ±1st-order diffracted light is the most intensive.

Since the concentric grooves are formed at certain intervals on the diffraction grating 37g, the exit angle of the +1st-order diffracted light and the exit angle of the −1st-order diffracted light are distributed axisymmetrically with respect to the rotational symmetry axis and have a certain angle regardless of the distance from the rotational symmetry axis. Accordingly, when a laser beam is incident on the diffraction grating 37g, the +1st-order diffracted light that widens at an angle of β with respect to the travel direction and the −1st-order diffracted light that narrows at an angle of β with respect to the travel direction exit the diffraction grating 37g, as shown in FIG. 8A.

The beam that exited the diffraction grating 37g is focused by the focusing lens 22g at a position away from the principal surface of the focusing lens 22g by the focal distance f. The light intensity distribution at this focusing position is an annular distribution with a low intensity region at the center. Accordingly, irradiation of the target material with the laser beam at this focusing position can improve the conversion efficiency.

The diameter D of the region with a high light intensity at the focusing position is indicated by the following expression.

D=2f·tan{sin⁻¹(λ/a)} (4)

Here, f is the focal distance of the focusing lens 22g; λ is the wavelength of the light; and a is the groove pitch.

The focusing optical system is not limited to the focusing lens 22g but may be a focusing mirror. The diffraction grating 37g is not limited to a transmissive concentric diffraction grating but may be a reflective diffraction grating.

Since the beam diameter of diffracted light can be increased according to the fifth embodiment, the target material can be irradiated with an annular laser beam having a sharper rise in light intensity than in the third embodiment described with reference to FIG. 6.

5.2.4 Forming Core and Hollow Distribution with Concentric Diffraction Grating and Focusing Optical System

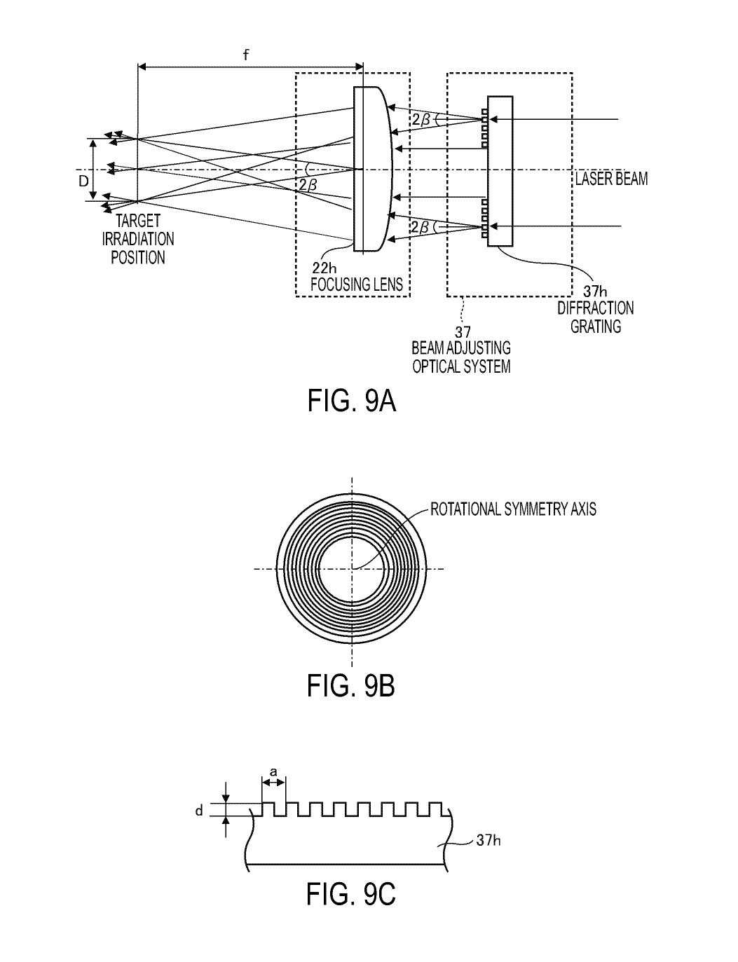

FIG. 9A is a diagram showing a sixth embodiment of the light intensity distribution adjusting optical system. The light intensity distribution adjusting optical system according to the sixth embodiment includes a diffraction grating 37h as the beam adjusting optical system 37 and a focusing lens 22h as the focusing optical system. FIG. 9B shows a surface on which a diffraction grating is formed; and FIG. 9C shows an enlarged view of a section of the groove of the diffraction grating.

As shown in FIGS. 9A and 9B, the diffraction grating 37h is a transmissive diffraction grating having concentric grooves formed thereon. However, the vicinity of the center of the diffraction grating 37h is not grooved but is planar. The diffraction grating 37h is arranged so that the rotational symmetry axis thereof is substantially aligned with the optical axis of the laser beam. As shown in FIG. 9C, the section of grooves of the diffraction grating 37h is rectangular. The grooves are machined so as to have a depth d represented by the following expression.

d=λ/{2(n−1)} (5)

Here, λ is the wavelength of the laser beam; and n is the refractive index of the diffraction grating 37h.

When light is orthogonally incident on the diffraction grating 37h (i.e., when the incident angle is 0 degree) as shown in FIG. 9A, the phases of light refracted by a plurality of grooves match to increase the amplitude on the conditions indicated by the following expression.

mλ=a·sinβ (6)

Here, m is the order of diffraction; λ is the wavelength of the light; a is the groove pitch; and β is the exit angle.

The beam that exited the diffraction grating 37h is focused by the focusing lens 22h at a position away from the principal surface of the focusing lens 22h by the focal distance f. The laser beam that passed through the plane part at the center of the diffraction grating 37h is focused in the vicinity of the optical axis and the laser beam that passed through the outer part having grooves of the diffraction grating 37h is focused annularly at a position outside the optical axis. Accordingly, the light intensity distribution at the focusing position is a core and hollow distribution having the first high intensity region, the low intensity region located inside the first high intensity region, and the second high intensity region located inside the low intensity region. Accordingly, irradiation of the target material with the laser beam at this focusing position can improve the conversion efficiency.

The focusing optical system is not limited to the focusing lens 22h but may be a focusing mirror. Although the diffraction grating 37h that has the plane part on which no grooves are formed at the center and has concentric grooves on the outside thereof is exemplarily described above, the diffraction grating may be formed in a different manner. For example, a diffraction grating that has concentric grooves at the center and a plane part with no grooves on the outside thereof may be used. The diffraction grating 37h is not limited to a transmissive concentric diffraction grating but may be a reflective diffraction grating.

Since the beam diameter of diffracted light can be increased according to the sixth embodiment, the target material can be irradiated with a core and hollow laser beam having a sharper rise in light intensity than in the fourth embodiment described with reference to FIG. 7.

### 5.2.5 Integration of Concentric Diffraction Grating and Focusing Optical System

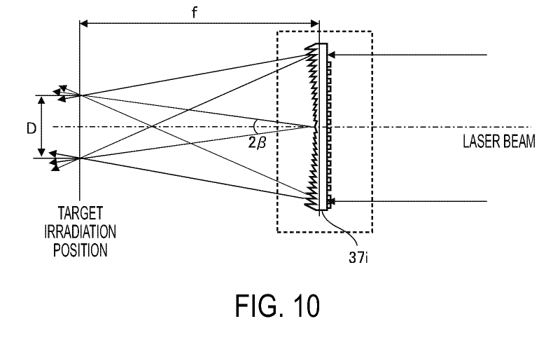

FIG. 10 is a diagram showing a seventh embodiment of the light intensity distribution adjusting optical system. The light intensity distribution adjusting optical system according to the seventh embodiment includes an optical element 37i in which a beam adjusting optical system and a focusing optical system are integrated. A concentric diffraction grating is formed on one side of the optical element 37i and a Fresnel lens is formed on the other side.

The structure and function of the diffraction grating formed on the optical element 37i are the same as the structure and function of the diffraction grating 37g according to the fifth embodiment described with reference to FIGS. 8A to 8C. The Fresnel lens formed on the optical element 37i is a lens in which a spherical lens is divided into concentric regions to reduce the thickness and has the same function as the focusing lens 22g according to the fifth embodiment. The optical element 37i is arranged so that the rotational symmetry axis thereof is substantially aligned with the optical axis of the laser beam.

The laser beam that entered the optical element 37i is annularly focused at a point away from the principal surface of the Fresnel lens by a focal distance f, as in the fifth embodiment. Therefore, according to the seventh embodiment, the same effect as in the fifth embodiment can be obtained. If the same diffraction grating as the diffraction grating 37h according to the sixth embodiment described with reference to FIGS. 9A to 9C is formed on the optical element 37i, the same effect as in the sixth embodiment can be obtained.

5.3 Forming Desired Beam intensity Distribution Using Diffraction Optical Element and Focusing Optical System

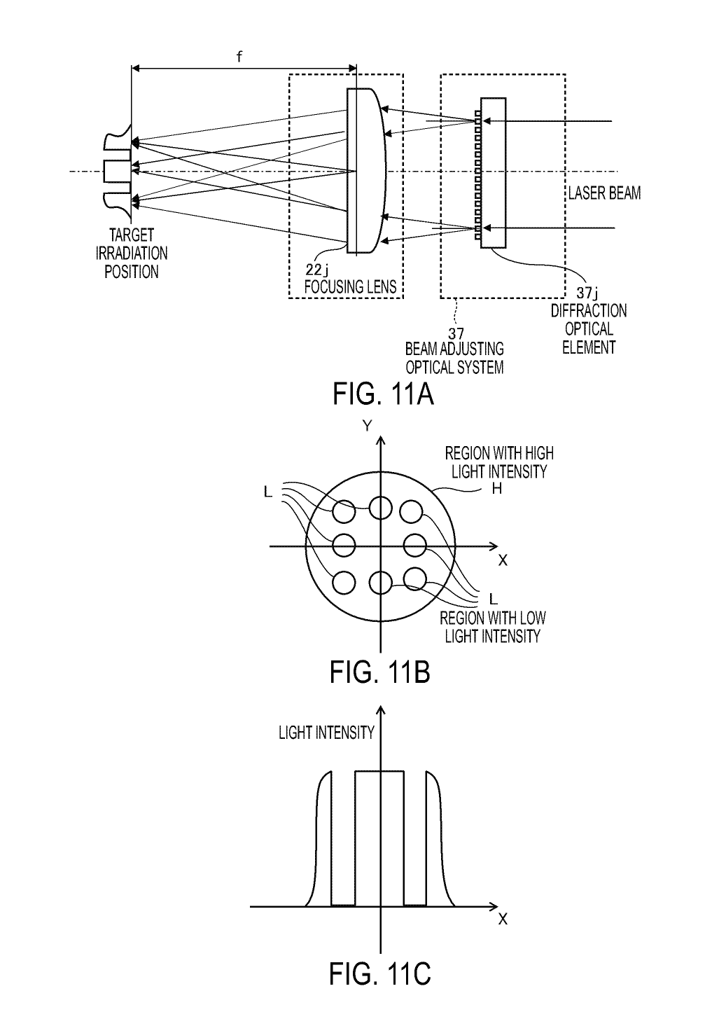

FIG. 11A is a diagram showing an eighth embodiment of the light intensity distribution adjusting optical system. The light intensity distribution adjusting optical system according to the eighth embodiment includes a diffractive optical element (DOE) 37j as the beam adjusting optical system 37 and a focusing lens 22j as the focusing optical system.

The diffractive optical element 37j has a concavo-convex pattern designed to form a desired light intensity distribution at the focusing position of the focusing lens 22j. The diffractive optical element 37j gives a phase difference π between the beam passing through the concave part and the beam passing through the convex part of the concavo-convex pattern and diffracts the beams passing through the individual parts. Interference occurs between the beams that are diffracted when passing through the individual parts.

The beam that exited the diffractive optical element 37j is focused by the focusing lens 22j and a diffraction image is formed at a position away from the principal surface of the focusing lens 22j by the focal distance f. Based on the Fresnel diffraction integral expression, the relationship between the light intensity distribution U (x′,y′) at the position (x′ y′ plane) at the focal distance f and the phase distribution given by the diffractive optical element 37j is expressed as below.

|U(x′,y′)|²=|F{exp[iφ(x,y)]}|² (7)

x′=λf/x (8)

Here, φ(x,y) is a phase distribution given on the x-y plane on which the concavo-convex pattern of the diffractive optical element 37j is formed. F{} represents Fourier transform; λ is the wavelength of the beam; and f is the focal distance of the focusing lens 22j. As described above, the diffraction image (light intensity distribution) formed at the focus position by the focusing lens 22j is represented by the Fourier transform of the concavo-convex pattern (phase distribution) of the diffractive optical element 37j.

Accordingly, the concavo-convex pattern of the diffractive optical element 37j can be designed by calculation to obtain a desired diffraction image. More specifically, a predetermined concavo-convex pattern is given to the diffractive optical element as the initial value and the concavo-convex pattern is optimized through repeated calculation so that the necessary diffraction image can be obtained by Fourier transform.

FIG. 11B shows an example of a light intensity distribution formed by the light intensity distribution adjusting optical system shown in FIG. 11A, viewed in the direction of irradiation with the laser beam. FIG. 11C shows an intensity distribution on the X-axis in FIG. 11B. In the intensity distribution shown in FIGS. 11B and 11C, there is a plurality of regions L with low light intensity surrounded by a region H with high light intensity. That is, since the region L with intensity lower than that in the periphery is located closer to the center than to the periphery, it can be speculated that, by irradiating the target material with such a laser beam, plasma jets from a space (with low light intensity) surrounded by a beam path of the high-light-intensity region H.

Particularly, in the light intensity distribution shown in FIGS. 11B and 11C, the plurality of regions L with low light intensity is arranged to surround the center. Accordingly, it can be speculated that high density plasma jetted from the plurality of low-density regions L is formed in a substantially cylindrical form from a broad viewpoint. As a result, it can be considered that a plasma flow from the center to the outside in the light intensity distribution is suppressed and the conversion efficiency is improved.

The focusing optical system is not limited to the focusing lens 22j but may be a focusing mirror. The diffractive optical element 37j is not limited to a transmissive diffractive optical element but may be a reflective diffractive optical element.

### 6. Embodiment of Target Supplier

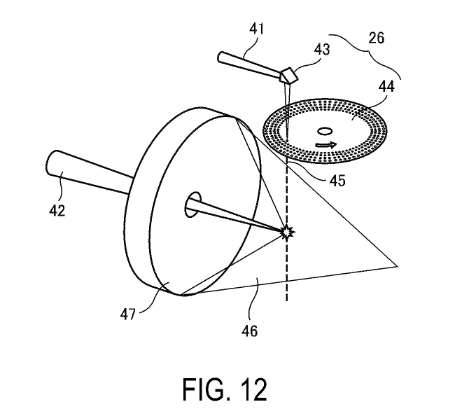

FIG. 12 is a diagram showing a target supplier in a ninth embodiment. FIG. 12 shows a target supplier 26 by a punch-out target system. The target supplier 26 includes a disc 44 to which the target material has been attached and an optical system 43 that focuses a target supply laser beam 41. The disc 44 includes a board that well transmits a laser beam 41, coated with the target material. The disc 44 is placed in the chamber 2 (see FIG. 1) so that the disc 44 is rotatable about the center of the board and is movable in parallel in a direction orthogonal to the rotational axis.

The target supply laser beam 41 is introduced from the outside of the chamber 2 (see FIG. 1), focused by the optical system 43, input from the rear of the disc 44 and passes through it, and strikes the target material application layer. The target material jumps out of the disc 44 due to a reaction against ablation by the irradiation with the laser beam 41. The target material 45 is irradiated with the laser beam 42 at the point of intersection of the travel path of the target material 45 and the beam path of a plasma generation laser beam 42. This generates plasma, and EUV light 46 emitted from the plasma is focused at a desired position by an EUV collector mirror 47.

The above description is not a restriction, but only an example. It will be clear for those skilled in the art that modifications can be made in the embodiments without departing from the scope of the invention as defined in the appended claims.

The terms used in this specification and the appended claims should be interpreted as “non-limiting.” For example, the terms “include” and “be included” should be interpreted as “not limited to the stated elements.” The term “have” should be interpreted as “not limited to the stated elements.” Further, the modifier “one (a/an)” should be interpreted as “at least one” or “one or more.”

What is claimed is:

1. An extreme ultraviolet light generation method comprising the steps of:
(a) supplying a target material into a chamber; and
(b) generating extreme ultraviolet light from plasma generated by irradiating the target material with a laser beam, the laser beam having a spatial light intensity distribution in which a low intensity region with a light intensity lower than a light intensity at a position away from a beam axis by a predetermined distance is present within an area extending for the predetermined distance from the beam axis at an irradiation position of the target material.

2. The extreme ultraviolet light generation method according to claim 1, wherein the predetermined distance is a distance equivalent to a half width at half maximum of the light intensity.

3. The extreme ultraviolet light generation method according to claim 1, wherein the laser beam has a high intensity region with a light intensity higher than that in the low intensity region closer to the beam axis than to the low intensity region at the irradiation position of the target material.

4. The extreme ultraviolet light generation method according to claim 1, wherein the spatial light intensity distribution of the laser beam at the irradiation position of the target material has a sharp rise in light intensity between the low intensity region and the position away from the beam axis by the predetermined distance.

5. An extreme ultraviolet light generation apparatus comprising:
a chamber;
a target supplier that supplies a target material into the chamber;
at least one optical element that introduces a laser beam for irradiating the target material to generate plasma into the chamber; and
a light intensity distribution adjusting optical system that adjusts a spatial light intensity distribution of the laser beam at an irradiation position of the target material so that a low intensity region with a light intensity lower than a light intensity at a position away from a beam axis by a predetermined distance is present within an area extending for the predetermined distance from the beam axis.

6. The extreme ultraviolet light generation apparatus according to claim 5, wherein the light intensity distribution adjusting optical system includes a first optical system that adjusts the laser beam so that the shape of a light intensity distribution in a section orthogonal to the beam axis becomes ring-shaped and a second optical system that focuses the beam exiting the first optical system.

7. The extreme ultraviolet light generation apparatus according to claim 5, wherein the light intensity distribution adjusting optical system includes a third optical system that refracts or reflects the laser beam at a certain angle axisymmetrically with respect to the beam axis and a fourth optical system that focuses the beam exiting the third optical system.

8. The extreme ultraviolet light generation apparatus according to claim 6, wherein the first optical system includes at least one of an axicon lens, an axicon mirror, and a concentric diffraction grating.

9. The extreme ultraviolet light generation apparatus according to claim 7, wherein the third optical system includes at least one of an axicon lens, an axicon mirror, and a concentric diffraction grating.

10. The extreme ultraviolet light generation apparatus according to claim 7, wherein the third optical system and the fourth optical system are provided on a single transmissive optical element, and the third optical system is formed on one surface of the transmissive optical element and the fourth optical system is formed on the other surface of the transmissive optical element.

11. The extreme ultraviolet light generation apparatus according to claim 5, wherein the target supplier supplies the target material by irradiating a target material with a second laser beam, the target material being attached to a surface of a transparent board, at least the surface of the transparent board being arranged in the chamber.
